(19) United States
(12) Patent Application Publication
(10) Pub. No.: US 2011/0102676 A1
(43) Pub. Date: May 5, 2011

(54) TELEVISION AND LOCKING METHOD THEREOF

(75) Inventor: LUNG DAI, Tu-Cheng (TW)

(73) Assignee: HON HAI PRECISION INDUSTRY CO., LTD., Tu-Cheng (TW)

(21) Appl. No.: 12/868,141

(22) Filed: Aug. 25, 2010

(30) Foreign Application Priority Data
Nov. 4, 2009 (CN) 200910309288.X

(51) Int. Cl. H04N 5/445; H04N 5/44

(52) U.S. Cl. 348/563; 348/553; 348/E05.099

(57) ABSTRACT

A locking method employed by a television includes steps of: obtaining time information according to a predetermined locking time; determining whether the obtained time information matches with the predetermined locking time; requiring users input a password; receiving an input password and determined whether the input password match with a predetermined password; locking the television if the input password does not match with the predetermined password.

### BACKGROUND

1. Technical Field

The present disclosure relates to a television, and particularly to a locking method performed by the television.

2. Description of Related Art

Many children are easily enthralled by TV programs. In particular, if parents are not at home, the children may watch too much TV and neglect homework or sleep.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a function block diagram of a television in accordance with an exemplary embodiment.

FIG. 2 is a user interface (UI) of the television in FIG. 1 in accordance with an exemplary embodiment.

FIG. 3 is a flowchart showing a locking method in accordance with an exemplary embodiment.

### DETAILED DESCRIPTION

The present disclosure provides a television with a locking function to enable parents or guardians to restrict television viewing for the children.

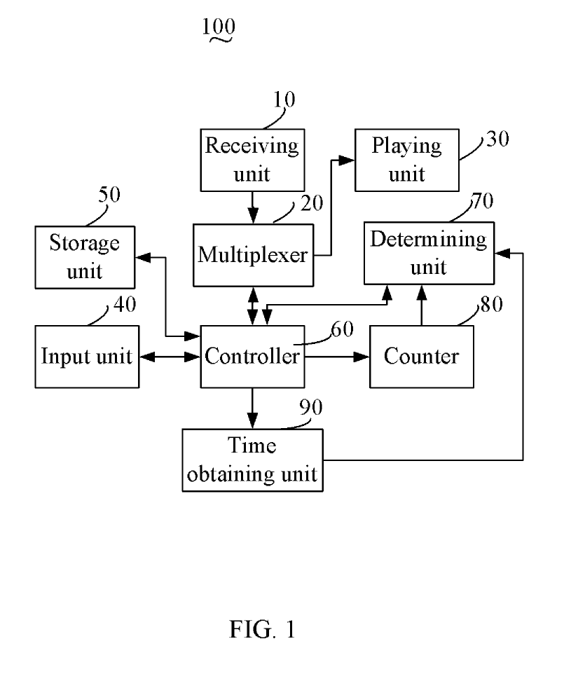

Referring FIG. 1, a television 100 as illustrated includes a receiving unit 10, a multiplexer 20, a playing unit 30, an input unit 40, a storage unit 50, a controller 60, a determining unit 70, a counter 80, and a time obtaining unit 90.

The receiving unit 10 is configured to receive television signals from a plurality of channels. The receiving unit 10 may be an antenna. The multiplexer 20 is configured to select one of the plurality of the channels in response to users' choice, and output the selected channel television signals to the playing unit 30 to display corresponding television programs.

The storage unit 50 is configured to store a predetermined password, a predetermined locking time, and a predetermined number of input times. The predetermined password, the predetermined locking time, and the predetermined number of the input times are set when the television is manufactured or set by users with the input unit 40. The input unit 40 may be a remote control device of the television 100. For example, to schedule times when the TV 100 can't be used without a password, and authorized user, that is, a user with password, can set parameters such as the predetermined locking time for when the television 100 can't be operated without the password. For example, if a parent wants a child to only be able to use the television 100 between the hours of 5 p.m. and 9 p.m. but for no longer than a total of 3 hours viewing time, then the predetermined locking time is set between 12:00 a.m. and 5 p.m. and between 9 p.m. and 12 p.m., and a viewing time of 3 hours.

The time obtaining unit 90 obtains time information of the start time and the viewing time of the television. The determining unit 70 is configured to determine whether the obtained time information matches with the predetermined locking time, and generates an interrupt signal if the obtained time information matches the predetermined locking time. For example, if the television 100 is turn on at 10 p.m. or the viewing time reaches 3 hours, it is determined that the time information matches with the predetermined locking time, and the determining unit 70 generates the interrupt signal.

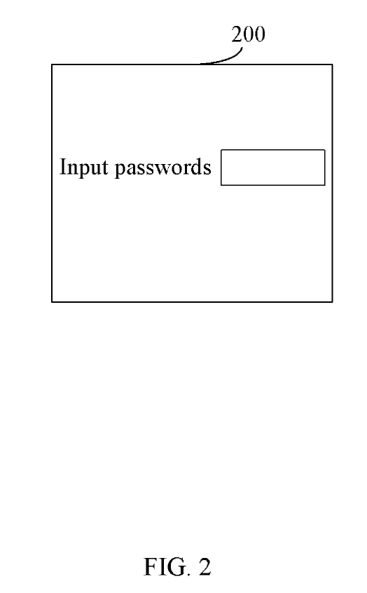

Referring also to FIG. 2, the controller 60 outputs a user interface (hereinafter “UI”) 200 on a screen (not shown) in response to the interrupt signal. The UI 200 is configured to enable the users to interact with the television 100, such as the UI 200 requires that a user input a password into the television 100 with the input unit 40.

The determining unit 70 is further configured to determine whether the input password matches with the predetermined password. For example, the determining unit 70 compares the input password with the predetermined password, if the input password is identical to the predetermined password, it is determined that the input password matches with the predetermined password, in other words, the input password is right. Otherwise, if the input password is different from the predetermined password, it is determined that the input password does not match with the predetermined password, in other words, the input password is wrong. If the input password is wrong, the determining unit 70 is further configured to output the interrupt signal to the controller 60, and the controller 60 outputs the UI 200 to allow a user to input the password again, at the same time, the counter 80 begins to count the number of times the wrong password is inputted. The determining unit 70 is also configured to determine whether the counted number of the times reaches the predetermined number of the input times, and generate a locking signal when the counted number of the times reaches the predetermined password input times. The controller 60 turns off the multiplexer 20 in response to the locking signal, thus, the television signals received by the receiving unit 10 are prevented from transmitting to the playing unit 30. In other words, the television 100 is locked and will not play television programs if the number of times the input password is wrong is equal to the predetermined password input times.

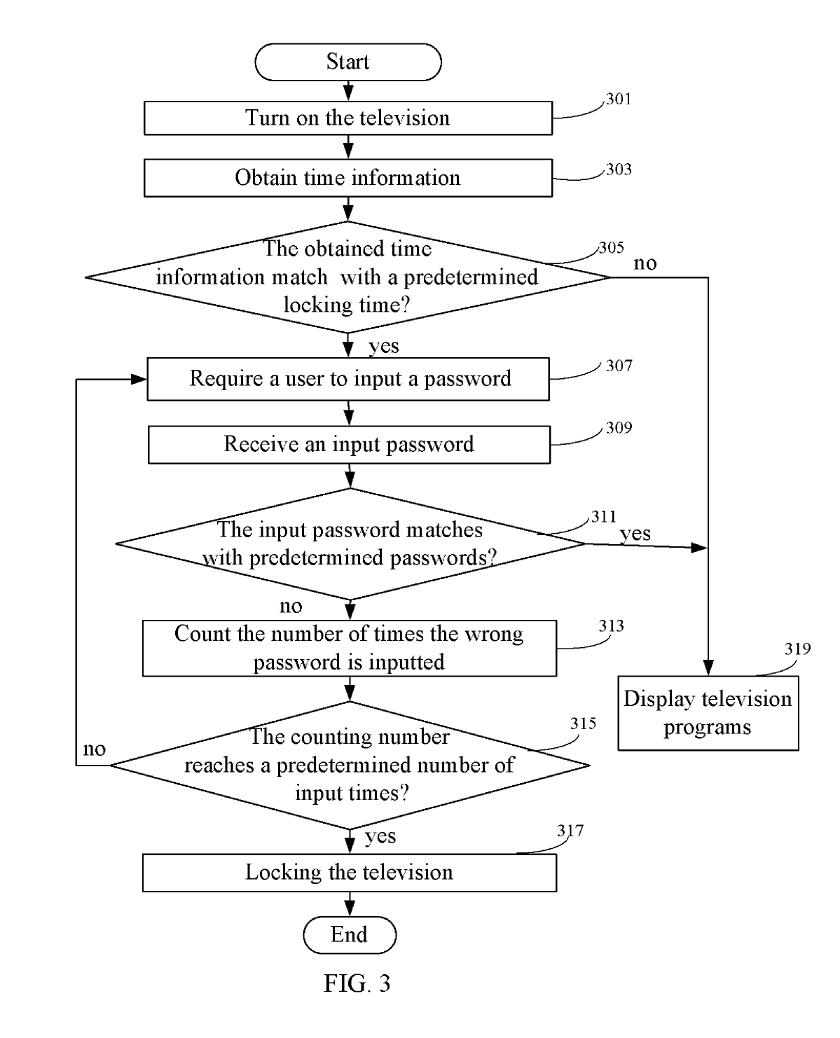

Referring to FIG. 3, a locking method employed by a television is illustrated. The television includes a playing unit, a receiving unit to receive television signals from a plurality of channels, and a multiplexer electrically connected to the receiving unit to select one of the plurality of the channels in response to users' choice, and output the selected television channel to the playing unit to display corresponding television programs. The locking method includes following steps.

In step 301, turning on the television.

In step 303, obtaining time information. The time information includes the start time of the television or the viewing time of the television.

In step 305, determining whether the obtained time information matches with the predetermined locking time. For example, if the predetermined locking time is set between 12:00 a.m. and 5 p.m. and between 9 p.m. and 12 p.m., and a viewing time of 3 hours. The television 100 is turned on at 10 p.m., the start time of the television reaches the predetermined locking time, it is determined that the obtained time information matches with the predetermined locking time. If the predetermined locking time is set as a viewing time of 3 hours, the television 100 total play 3 hours, the viewing time of the television 100 reaches the predetermined locking time, it is determined that the obtained time information matches with the predetermined locking time.

In step 307, displaying a UI to require users to input a password if the time information matches with the predetermined locking time.

In step 309, receiving an input password input by the users.

In step 311, determining whether the input password matches with predetermined password.

In step 313, counting the number of times the wrong password is inputted.

In step 315, determining whether the counted number of the times reaches a predetermined number of input times.

In step 317, locking the television by turning off the multiplexer if the counted number of the times reaches the predetermined input times.

In step 319, displaying television programs if the obtained time information does not match with the predetermined locking time or the input password matches with predetermined password.

It is to be understood, however, that even though information and advantages of the present embodiments have been set forth in the foregoing description, together with details of functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A television comprising:
a time obtaining unit to obtain time information;
a determining unit to determine whether the time information matches with a predetermined locking time; and
a controller to require users to input a password if the time information matches with the predetermined locking time; the controller being further to control the television to lock if the input password does not match with a predetermined password.

2. The television according to claim 1, wherein the obtain time information comprises a start time of the television, the start time is the time when the television is turned on.

3. The television according to claim 1, wherein the obtain time information comprises a viewing time of the television.

4. The television according to claim 1, further comprising a storage unit to store the predetermined locking time and the predetermined password.

5. The television according to claim 1, further comprising a receiving unit, a playing unit, and a multiplexer, the receiving unit being configured to receive television signals from a plurality of channels, the multiplexer being configured to select one of the plurality the channels in response to users' choice, and output the selected channel television signals to the playing unit to display corresponding television programs, the controller being configured to turn off the multiplexer to lock the television.

6. The television according to claim 1, further comprising a counter, the counter being configured to count the number of times the wrong password is inputted, if the input password does not match with the predetermined password, the determining unit being further configured to determine whether the counted number of the times reaches a predetermined number of input times, the controller controlling the television to lock if the counted number of the times reaches to the predetermined number of the input times.

7. The television according to claim 1, wherein, the controller further outputs a user interface (UI) to require the users input the password.

8. A locking method employed by a television comprising steps of:
obtaining time information;
determining whether the obtained time information matches with a predetermined locking time;
requiring users input a password;
receiving an input password and determined whether the input password match with a predetermined password;
locking the television if the input password does not match with the predetermined password.

9. The locking method according to claim 8, further comprising: displaying a UI to require the users to input the password.

10. The locking method according to claim 8, wherein the obtained time comprises a start time of the television, the start time is the time when the television is turned on.

11. The locking method according to claim 8, wherein the obtained time comprises a viewing time of the television.

12. The locking method according to claim 8, further comprising steps before the step of locking the television:
counting the number of times the wrong password inputted if the input password does not match with the predetermined password;
determining whether the counted number of times reaches a predetermined number of input times;
locking the television if the counted number of times reaches to the predetermined number of the input times.

13. The locking method according to claim 8, wherein locking the television is performed by turning off a multiplexer of the television, the multiplexer is configured to select one channel television signals in response to the users' choice.
